(19) United States
(12) Patent Application Publication
(10) Pub. No.: US 2026/0166386 A1
(43) Pub. Date: Jun. 18, 2026

(54) GOLF BALL

(71) Applicant: BRIDGESTONE SPORTS CO., LTD., Tokyo (JP)

(72) Inventor: Kanae TAJIMA, Chichibushi (JP)

(73) Assignee: BRIDGESTONE SPORTS CO., LTD., Tokyo (JP)

(21) Appl. No.: 19/404,699

(22) Filed: Dec. 1, 2025

(30) Foreign Application Priority Data
Dec. 16, 2024 (JP) 2024-220293

(51) Int. Cl. A63B 37/00; C09D 7/65; C09D 175/06

(52) U.S. Cl. CPC A63B 37/00221; C09D 7/65; C09D 175/06; A63B 37/0075; A63B 2209/00

(57) ABSTRACT

The present invention provides a golf ball including at least one coating layer on a surface of the golf ball having a large number of dimples, in which at least one layer of the coating layer is formed of a two-liquid curable urethane coating composition containing a polyol component and a polyisocyanate component, a molar ratio (NCO group/OH group) of an isocyanate group (NCO group) of the polyisocyanate component to a hydroxyl group (OH group) of the polyol component is from 0.50 to 0.88, and a 10% modulus of the coating layer based on measurement of JIS K 7161 (2014) is not more than 3.0 MPa.

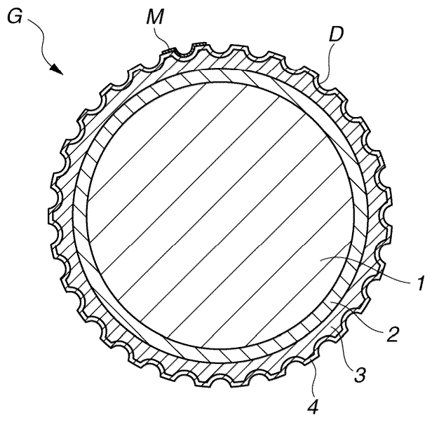

### CROSS-REFERENCE TO RELATED APPLICATIONS

This non-provisional application claims priority under 35 U.S.C. § 119 (a) on Patent Application No. 2024-220293 filed in Japan on Dec. 16, 2024, the entire contents of which are hereby incorporated by reference.

### TECHNICAL FIELD

The present invention relates to a golf ball having a coating layer formed of a two-liquid curable urethane coating material on a ball surface, and more specifically, to a golf ball excellent in printability when a mark is printed on the coating layer by inkjet or the like.

### BACKGROUND ART

In recent years, shapes and colors of marks on the coating layer tend to be diversified, and the appearance of a golf ball including a mark has greatly affected the commercial value of the golf ball itself. Therefore, when the mark is partially peeled off due to the use of the golf ball or the like, even if there is no problem in the performance of the golf ball itself, its commercial value is greatly reduced or the mark becomes the subject of complaints.

In particular, when a mark is printed on a coating film, there has been a problem in that the mark is easily peeled off. In recent years, an owner's name (including an alignment mark) is often applied on a coating film. For the formation of the owner's name, a desired mark is often printed after the ball surface is coated. When a printed mark such as the owner's name is inkjet printed and exists on the surface of the ball, since the printed mark is exposed, the printed mark is frequently peeled or chipped due to long-term use of the ball, which causes a problem in printability such as mark durability.

Patent documents in the past have examined a molar ratio (NCO/OH) of a coating composition and an elastic modulus of a coating material for the purpose of forming a base treatment or a protective film for improving mark durability, or for the purpose of improving a feel at impact and stain resistance of a golf ball. For example, Patent Document 1 proposes a method for manufacturing a golf ball in which an underlayer is formed at a position corresponding to a mark, and the mark is formed on the underlayer by inkjet printing. Patent Document 2 proposes a method in which a portion where a mark is to be formed is heated to 40 to 70° C., and then the heated state is maintained to form a mark by inkjet printing using an aqueous resin ink. Patent Document 3 proposes forming a protective coating film of an aqueous clear coating material or an oily clear coating material on an inkjet-printed mark portion. Patent Document 4 proposes that a golf ball in which a base resin constituting a coating film is polyurethane, the molar ratio (NCO/OH) of a hydroxyl group (OH group) of a polyol component to an isocyanate group (NCO group) of a polyisocyanate component is at least 0.6, and the elastic modulus of the coating film is not more than 300 MPa is excellent in the feel at impact and stain resistance.

However, even in these proposed golf balls, marks such as the owner's name on the coating film may still be peeled off, and it is difficult to say that printability such as mark durability is sufficient.

### CITATION LIST

Patent Document 1: JP-A 2024-055321
Patent Document 2: JP-A 2007-260356
Patent Document 3: JP-A H02-128774
Patent Document 4: JP-A 2016-123632

### SUMMARY OF THE INVENTION

The present invention has been made in view of the above circumstances, and an object of the present invention is to provide a golf ball excellent in printability such as mark durability while securing discoloration properties and durability of a coating layer.

As a result of intensive studies to achieve the above object, the present inventor has found that in a golf ball including at least one coating layer on a surface of the golf ball having a large number of dimples, at least one layer of the coating layer is formed of a two-liquid curable urethane coating composition containing a polyol component and a polyisocyanate component, a molar ratio (NCO group/OH group) of an isocyanate group (NCO group) of the polyisocyanate component to a hydroxyl group (OH group) of the polyol component is set within a range of from 0.50 to 0.88, and a 10% modulus of the coating layer is adjusted to not more than 3.0 MPa, so that printability such as mark durability is excellent while discoloration properties and durability of the coating layer are secured, and thus has completed the present invention.

Accordingly, the present invention provides a golf ball including
at least one coating layer on a surface of the golf ball having a large number of dimples, wherein at least one layer of the coating layer is formed of a two-liquid curable urethane coating composition containing a polyol component and a polyisocyanate component, a molar ratio (NCO group/OH group) of an isocyanate group (NCO group) of the polyisocyanate component to a hydroxyl group (OH group) of the polyol component is from 0.50 to 0.88, and a 10% modulus of the coating layer based on measurement of JIS K 7161 (2014) is not more than 3.0 MPa.

In a preferred embodiment of the golf ball according to the invention, the coating composition contains an unreactive resin, and a compounding amount of the unreactive resin is from 0.1 to 5.0 parts by weight per 100 parts by weight of a coating material solid content.

In another preferred embodiment of the inventive golf ball, the unreactive resin is a cellulose-based resin.

In yet another preferred embodiment, the cellulose-based resin is cellulose acetate butyrate (CAB) or nitrocellulose.

In still another preferred embodiment, the polyisocyanate component includes hexamethylene diisocyanate (HDI) and toluene diisocyanate (TDI), and a compounding ratio thereof is from 90/10 to 40/60 in terms of HDI/TDI (weight ratio).

In a further preferred embodiment, the polyol component is an acrylic-based polyol or a polyester-based polyol.

In a yet further preferred embodiment, a peak temperature of a loss tangent (tan δ) obtained by measuring a dynamic viscoelasticity of the coating layer is not more than 40° C.

In a still further preferred embodiment, the coating layer has a peak height of the loss tangent (tan δ) of 0.70 to 0.90.

In another preferred embodiment, the coating layer includes two layers of an inner layer and an outer layer, the outer layer has a thickness of from 10 to 20 μm, and the inner layer has a thickness of from 3 to 7 μm.

### Advantageous Effects of the Invention

According to the golf ball of the present invention, printability such as mark durability is excellent while the discoloration properties and durability of the coating layer are secured.

### BRIEF DESCRIPTION OF THE DRAWING

The FIGURE is a schematic cross-sectional view of a golf ball according to one embodiment of the present invention.

### DETAILED DESCRIPTION OF THE INVENTION

Hereinafter, the present invention is described in more detail.

The golf ball of the present invention has a coating layer obtained by applying a coating composition to a ball surface having a large number of dimples. A role of the coating layer is to protect an entire ball and to impart glossiness and aesthetics to the ball surface. Specifically, a two-liquid curable urethane coating composition containing a polyol component and a polyisocyanate component is used.

Examples of the polyol component include acrylic-based polyols and polyester-based polyols. These polyols include modified products of polyols, and other polyols may also be added in order to further improve workability.

Examples of the acrylic-based polyol include homopolymers or copolymers of monomers having a functional group reactive with isocyanate, examples of such monomers include (meth)acrylic acid alkyl esters, and specific examples thereof include methyl (meth)acrylate, ethyl (meth)acrylate, isopropyl (meth)acrylate, butyl (meth)acrylate, isobutyl (meth)acrylate, 2-ethylhexyl (meth)acrylate, lauryl (meth)acrylate, stearyl (meth)acrylate, cyclohexyl (meth)acrylate, isobornyl (meth)acrylate, 2-hydroxyethyl (meth)acrylate, 2-hydroxypropyl (meth)acrylate, and 4-hydroxybutyl (meth)acrylate. These may be used singly, or two or more may be used in combination.

As a modified product of the acrylic-based polyol, for example, a polyester-modified acrylic-based polyol may be used. Examples of other polyols include polyether polyols such as polyoxyethylene glycol (PEG), polyoxypropylene glycol (PPG), and polyoxytetramethylene glycol (PTMG); condensation polyester polyols such as polyethylene adipate (PEA), polybutylene adipate (PBA), and polyhexamethylene adipate (PH2A); lactone polyester polyols such as poly-8-caprolactone (PCL); and polycarbonate polyols such as polyhexamethylene carbonate. These may be used singly, or two or more may be used in combination. A ratio of these polyols to a total amount of the acrylic-based polyols is preferably not more than 50 wt %, and more preferably not more than 40 wt %.

The polyester-based polyol is obtained by polycondensation of a polyol and a polybasic acid. Examples of the polyol include diols such as ethylene glycol, 1,2-propanediol, 1,3-propanediol, 1,3-butanediol, 1,4-butanediol, 1,6-hexanediol, neopentyl glycol, diethylene glycol, dipropylene glycol, hexylene glycol, dimethylolheptane, polyethylene glycol, and polypropylene glycol; triols; tetraols; and polyols having an alicyclic structure. Examples of the polybasic acid include aliphatic dicarboxylic acids such as succinic acid, adipic acid, sebacic acid, azelaic acid, and dimer acid; aliphatic unsaturated dicarboxylic acids such as fumaric acid, maleic acid, itaconic acid, and citraconic acid; aromatic polyvalent carboxylic acids such as phthalic acid, isophthalic acid, terephthalic acid, trimellitic acid, and pyromellitic acid; dicarboxylic acids having an alicyclic structure such as tetrahydrophthalic acid, hexahydrophthalic acid, 1,3-cyclohexanedicarboxylic acid, 1,4-cyclohexanedicarboxylic acid, and endomethylene tetrahydrophthalic acid; and tris-2-carboxyethyl isocyanurate.

As the polyol component, in addition to only one kind of polyester polyol, two kinds of polyester polyols may be used in combination. If two types of polyester polyols are used in combination, examples thereof include the following components (A) and (B). As the polyester polyol serving as the component (A), a polyester polyol in which a cyclic structure is introduced into a resin skeleton may be employed, and examples thereof include a polyester polyol obtained by polycondensation of a polyol having an alicyclic structure such as cyclohexanedimethanol and a polybasic acid, or polycondensation of a polyol having an alicyclic structure and a diol or a triol and a polybasic acid. On the other hand, as the polyester polyol serving as the component (B), a polyester polyol having a multi-branched structure may be employed, and examples thereof include polyester polyols having a branched structure such as “NIPPOLAN 800” manufactured by Tosoh Corporation.

A total weight average molecular weight (Mw) of a main component composed of the two types of polyester polyols is preferably from 13,000 to 23,000, and more preferably from 15,000 to 22,000. A total numerical average molecular weight (Mn) of the main component composed of the two types of polyester polyols is preferably from 1,100 to 2,000, and more preferably from 1,300 to 1,850. If these average molecular weights (Mw and Mn) deviate from the above range, an abrasion resistance of the coating layer may be deteriorated. The weight average molecular weight (Mw) and the numerical average molecular weight (Mn) are measured values (in terms of polystyrene) by gel permeation chromatography (hereinafter, abbreviated as GPC) measurement by differential refractometer detection.

Compounding amounts of the two types of polyester polyols (A) and (B) are not particularly limited, although the compounding amount of the component (A) is preferably from 20 to 30 wt % with respect to a total amount of the main component, and the compounding amount of the component (B) is preferably from 2 to 18 wt % with respect to the total amount of the main component.

On the other hand, the polyisocyanate is not particularly limited, and is a generally used aromatic, aliphatic, alicyclic, or the like polyisocyanate, and specific examples thereof include hexamethylene diisocyanate (HDI), toluene diisocyanate (TDI), diphenylmethane diisocyanate, xylylene diisocyanate, tetramethylene diisocyanate, lysine diisocyanate, isophorone diisocyanate, 1,4-cyclohexylene diisocyanate, naphthalene diisocyanate, trimethylhexamethylene diisocyanate, dicyclohexylmethane diisocyanate, 1-isocyanato-3,3,5-trimethyl-4-isocyanatomethylcyclohexane, and the like. These may be used singly or in combination.

Examples of a modified product of hexamethylene diisocyanate described above include polyester modified products and urethane modified products of hexamethylene diisocyanate. Examples of a derivative of hexamethylene diisocyanate described above include a nurate form (isocyanurate form), a biuret form, and an adduct form of hexamethylene diisocyanate.

In the present invention, as the polyisocyanate component, hexamethylene diisocyanate (HDI) and toluene diisocyanate (TDI) are preferably used in combination. In this case, a compounding ratio of these polyisocyanate components is preferably from 90/10 to 40/60, and more preferably from 80/20 to 50/50 in terms of HDI/TDI (weight ratio).

A molar ratio (NCO group/OH group) of an isocyanate group (NCO group) of the polyisocyanate to a hydroxyl group (OH group) of the polyol needs to be within a range of from 0.50 to 0.88, is preferably at least 0.60, and more preferably at least 0.70, and the upper limit is preferably not more than 0.85. That is, by making the molar ratio slightly smaller than the molar ratio usually used, a network of a urethane crosslinked structure becomes slightly loose, ink easily enters the crosslinked structure, and top coating properties may be improved. If the molar ratio is too low, stain resistance may be deteriorated, and if the molar ratio is too high, the coating layer may be brittle.

As a curing catalyst (organometallic compound), an amine-based catalyst or an organometallic catalyst may be used, and as the organometallic compound, a compound conventionally blended as a curing agent for a two-liquid curable urethane coating material, such as a metal soap of aluminum, nickel, zinc, tin, or the like, may be suitably used.

Various organic solvents may be mixed with the coating composition depending on coating conditions. Examples of the organic solvent include aromatic solvents such as toluene, xylene, and ethylbenzene; ester solvents such as ethyl acetate, butyl acetate, propylene glycol methyl ether acetate, and propylene glycol methyl ether propionate; ketone solvents such as acetone, methyl ethyl ketone, methyl isobutyl ketone, and cyclohexanone; ether solvents such as diethylene glycol dimethyl ether, diethylene glycol diethyl ether, and dipropylene glycol dimethyl ether; alicyclic hydrocarbon solvents such as cyclohexane, methyl cyclohexane, and ethyl cyclohexane; and petroleum hydrocarbon solvents such as mineral spirits.

In the present invention, it is preferable that the coating composition contains an unreactive resin. Specifically, the unreactive resin is preferably a cellulose-based resin such as cellulose acetate butyrate (CAB) or nitrocellulose. If this unreactive resin is added to the coating composition, a vicinity of a surface of the coating layer may be modified. That is, the unreactive resin functions so that the coating layer may maintain a smooth state after a substrate is applied or during curing, adhesion between the coating material and a mark is increased, and mark durability may be improved.

A compounding amount of the unreactive resin is from 0.1 to 5.0 parts by weight, preferably at least 0.5 parts by weight, and more preferably at least 1.0 part by weight per 100 parts by weight of a coating material solid content, and the upper limit thereof is preferably not more than 4.0 parts by weight, and more preferably not more than 3.0 parts by weight. If the compounding amount is too large, viscosity may be increased and workability may worsen, whereas if the compounding amount is too small, compatibility between the coating material and the mark may worsen.

A known coating blending component may be added to the coating composition as necessary. Specifically, a thickener, an ultraviolet absorber, a fluorescent brightener, a slipping agent, a pigment, and the like may be blended in an appropriate amount.

A thickness of the coating layer formed of the coating composition is not particularly limited, although the thickness is usually from 5 to 40 μm, and preferably from 10 to 20 μm. Here, the thickness of the coating layer means not the thickness of the coating layer formed in a dimple but the thickness of the coating layer formed on the ball surface (that is, also referred to as a land portion or a bank portion) other than the dimple.

The coating layer may be formed of two layers of an inner layer and an outer layer. In this case, a thickness of the inner layer is preferably from 3 to 7 μm, and more preferably from 4 to 6 μm, and a thickness of the outer layer is preferably from 10 to 20 μm, and more preferably from 12 to 18 μm. If the coating layer is formed in multiple layers as described above, it is preferable to use the coating composition as an outermost layer from the viewpoint of sufficiently securing a desired effect of the present invention.

When the coating composition is used, the coating composition may be adjusted at the time of coating a golf ball manufactured by a known method, applied to the surface by adopting a normal coating step, and subjected to a drying step to form a coating layer on the ball surface. In this case, as the coating method, a spray coating method, an electrostatic coating method, a dipping method, or the like may be suitably adopted, and there is no particular limitation.

The drying step is the same as that of a known two-liquid curable urethane coating material, and a drying temperature may be at least about 40° C., and particularly from 40 to 60° C., and a drying time may be from 20 to 90 minutes, and particularly from 40 to 50 minutes.

By applying a corona treatment, a plasma treatment, an ultraviolet irradiation treatment, an electron beam irradiation treatment, or the like to the cover surface, which is a base for forming the coating layer, the adhesion between the cover surface and the coating layer may be improved, and therefore these surface treatments may be suitably employed.

The coating composition may be used for any golf ball such as a one-piece golf ball, a two-piece solid golf ball including a core and a cover encasing the core, or a multi-piece solid golf ball including one or more layers of a core and a multi-layer cover encasing the core.

A 10% modulus of the coating layer formed of the coating composition is not more than 3.0 MPa, preferably not more than 2.5 MPa, and more preferably not more than 2.0 MPa, and the lower limit thereof is preferably at least 1.0 MPa, more preferably at least 1.2 MPa, and still more preferably at least 1.4 MPa. Specifically, the “10% modulus” refers to a test piece produced by punching a cured product obtained by curing a coating composition into a test piece type 2 defined in JIS K 7127 (1999), and for this test piece, tensile stress at 10% strain (10% modulus) is measured in accordance with JIS K 7161 (2014). If the 10% modulus of the coating layer is not more than 3.0 MPa, the coating layer becomes a flexible coating layer, and the coating layer may also be smoothly deformed following ball deformation when struck with a club, so that chipping and cracking of the mark on the coating layer may be prevented as much as possible, and as a result, mark durability is improved.

In a dynamic viscoelasticity test of the coating layer formed of the coating composition, a peak height of a loss tangent (tan δ) is preferably at least 0.70, more preferably at least 0.74, and still more preferably at least 0.77, and the upper limit thereof is preferably not more than 0.90, and more preferably not more than 0.87. A temperature (peak temperature) at this peak height is preferably not more than 40° C., and more preferably at least 20° C. and not more than 35° C. A coating layer having a loss tangent (tan δ) within the above range has a high frictional force and a large shear force, and as a result, a high spin rate may be obtained on approach shots.

The loss tangent (tan δ) of the coating layer formed of the coating composition is represented by a value obtained by dividing a loss elastic modulus by a storage elastic modulus, and is also referred to as a dynamic viscoelastic modulus. This loss tangent (tan δ) may be measured with a commercially available measuring apparatus, for example, a device for measuring dynamic viscoelasticity (DMA Q800) manufactured by TA Instruments.

The golf ball of the present invention has at least one coating layer on a ball surface having a large number of dimples, but an internal structure of the ball usually includes a core and a cover composed of at least one layer.

The core may be formed using a known rubber material as a substrate. A known base rubber such as a natural rubber or a synthetic rubber may be used as the base rubber, and more specifically, it is recommended to mainly use polybutadiene, particularly cis-1,4-polybutadiene having at least at least 40% cis structure. In addition, in the base rubber, a natural rubber, a polyisoprene rubber, a styrene butadiene rubber, and the like may be used in combination with the above-described polybutadiene as desired. The polybutadiene may be synthesized by a Ziegler-type catalyst such as a titanium-based catalyst, a cobalt-based catalyst, a nickel-based catalyst, or a neodymium-based catalyst, or by a metal catalyst such as cobalt or nickel.

In the base rubber, a co-crosslinking agent such as an unsaturated carboxylic acid and a metal salt thereof, an inorganic filler such as zinc oxide, barium sulfate, or calcium carbonate, an organic peroxide such as dicumyl peroxide or 1,1-bis(t-butylperoxy)cyclohexane, or the like may be blended. If necessary, a commercially available antioxidant or the like may be appropriately added.

The core is a heat-molded product obtained by heat-curing the rubber material. The core may be a single-layer core or a multi-layer core, and the heat-molded product may be used for all or a part of the single layer or the plurality of layers of the core. For example, the core may be manufactured by intensively mixing the rubber composition using a mixing apparatus such as a Banbury mixer or a roll mill, subsequently compression molding or injection molding the mixture using a core mold, and curing the resulting molded body by appropriately heating the molded body at a temperature sufficient for the organic peroxide or the co-crosslinking agent to act, such as at a temperature of approximately 100 to 200° C., and for 10 to 40 minutes.

The cover is a member that encases the core and has at least one layer, and examples thereof include a two-layer cover and a three-layer cover. In the case of a two-layer cover, each layer may be referred to as an intermediate layer on the inner side and an outermost layer on the outer side. In the case of a three-layer cover, the layers may be referred to in order from the inner side as a surrounding layer, an intermediate layer, and an outermost layer. A large number of dimples are typically formed on an outside surface of the outermost layer in order to improve aerodynamic properties of the ball.

A material of each layer of the cover is not particularly limited, and may be formed of, for example, an ionomer resin, a polyester resin, a polyamide resin, or a polyurethane resin. For example, the intermediate layer may be formed of an ionomer resin or a highly neutralized ionomer resin, and the outermost layer may be formed of a polyurethane resin.

A method for forming the respective cover layers may be performed by a customary method such as a known injection molding method. For example, it is also possible to produce a two-piece golf ball having a cover surrounding a core by injecting a cover material around the core with an injection mold to obtain a layer-encased sphere, or by enclosing the core within two half cups pre-molded into hemispherical shapes as an intermediate layer material and molding the half cups under applied heat and pressure.

Specific examples of the layer structure of the golf ball of the present invention include a ball structure shown in the FIGURE. The FIGURE is a golf ball G having a three-layer structure including a core 1, an intermediate layer 2 encasing the core 1, and a cover 3 encasing the intermediate layer. The intermediate layer is formed in a single layer, but may be formed in multiple layers, and may be a two-piece golf ball with a core without an intermediate layer and with a single-layer cover. The cover 3 is positioned at the outermost layer in the layer structure of the golf ball except for a coating film layer. A large number of dimples D are typically formed on a surface of the cover (outermost layer) 3 in order to improve aerodynamic properties of the ball. In addition, a coating layer 4 is formed on the surface of the cover 3, and a mark M such as an owner's name is applied outside the coating layer.

A method for printing the mark M on the surface of the coating layer is not particularly limited, and various methods conventionally adopted such as an inkjet method, a transfer film method using transfer tape or the like, and a pad method (engraving method) may be adopted. However, the present invention is particularly useful when the mark is formed by a printing method using an inkjet method.

In the golf ball of the present invention, properties of the ball such as a ball weight and diameter may be appropriately set according to the Rules of Golf. That is, the golf ball may be formed to have a diameter of at least 42.67 mm and a weight of not more than 45.93 g.

### EXAMPLES

Hereinafter, the present invention is specifically described with reference to Examples and Comparative Examples, but the present invention is not limited to the following Examples.

### Examples 1 to 6 and Comparative Example 1

A golf ball with dimples, which was encased by injection molding an ionomer resin cover having a thickness of 1.25 mm on a core having a diameter of 40.2 mm, was prepared and coated.

In Examples 1 to 4 and Comparative Example 1, the coating was performed in two layers, and an inner coating layer (hereinafter, referred to as a “coating film”) was coated with an aqueous primer with an automatic spray gun so as to have a thickness of 5 μm. An aqueous primer composition is a material obtained by mixing an acrylic primer (main component) manufactured by Cashew Co., Ltd., “Crosslinker CX-100” (curing agent), and water at a weight ratio of 100:1.5:3. This material was dried at 55° C. for 30 minutes and subjected to a test.

Next, for the outer coating film (coating layer), a coating composition including a main component and a curing agent shown in Table 1 was used, and this composition was applied with an automatic spray gun so that the thickness of the coating film was 15 μm.

A mark was printed on the coated golf ball surface by inkjet printing. Printing of the mark was performed using a printing machine “VersaUV LEF2-200” manufactured by Roland DGA Corporation, and as the ink, “ECO-UV” manufactured by Roland DGA Corporation was used.

In Example 5 and Example 6, as described above, a coating film (coating layer) of an inner layer is produced, and for the outer coating film (coating layer), a coating composition including the main component and the curing agent shown in Table 1 is used, and the coating composition is applied with an automatic spray gun so that the thickness of the coating layer is 15 μm. In the same manner as described above, the mark is printed on the coated golf ball surface by inkjet printing.

Sheet physical properties of the coating film produced in each example are as follows.

### [10% Modulus (MPa)]

Tensile properties of the coating film were measured in accordance with JIS K 7161 (2014). Specifically, the coating material was dried and cured at 40° C. for four hours to produce a coating film (thickness: 0.05 mm). This coating film was punched into a test piece type 2 (width of parallel section: 10 mm, gauge length: 50 mm) defined in JIS K 7127 (1999) to produce a test piece. This test piece was subjected to a tensile test using a testing machine “Tensilon RTG-1310” manufactured by A&D Company, Limited. Test conditions were a distance between grips of 100 mm, a tensile speed of 50 mm/min, and a test temperature of 23° C. A tensile stress (10% modulus) at 10% strain at the time of the test was recorded.

### [Measurement of Friction Coefficient]

A friction coefficient of the coating film was measured in accordance with JIS K 7125 (1999). Specifically, the coating material was dried and cured at 40° C. for four hours to produce a coating film (thickness: not more than 0.5 mm). A test piece was produced such that this coating film had a size of 80 mm×200 mm, a thickness of not more than 0.5 mm, and a contact surface area of 40 cm² (length of one side: 63 mm). This test piece was tested using a testing machine “Tensilon RTG-1310” manufactured by A&D Company, Limited. Test conditions were a speed of 100 mm/min, a test temperature of 23° C., and a sliding piece of 200 g±2 g. A frictional force at the time of the test was measured. Friction is distinguished into static friction and dynamic friction.
Static friction: Friction when a threshold is exceeded at the start of sliding.
Dynamic friction: Friction during sustained sliding motion at a given speed.
Static friction coefficient: A force increases in a straight line to give friction and reach the maximum load. This peak represents a static frictional force Fs. The static friction coefficient us is given by the following formula.

μs=Fs/N [Fs: static frictional force (N)]
Dynamic friction coefficient: The frictional force acting during the sliding motion often varies from a constant value appearing in an ideal state, due to secondary effects related to an increase in travel distance. A dynamic frictional force FD is an average value up to the first 6 cm after the peak Fs of the static frictional force is ignored and a relative sliding motion between contact surfaces is started. A dynamic friction coefficient μD is calculated from the dynamic frictional force using the following formula.

μD=FD/N [FD: dynamic frictional force (N)]

### [Peak Height and Peak Temperature of Loss Tangent Tan δ]

A loss tangent (tan δ) of the coating film was measured under the following conditions.
Apparatus: Dynamic viscoelasticity measuring device “Q800” manufactured by TA Instruments.
Measurement sample: A coating composition containing a main component and a curing agent was dried and cured at 40° C. for four hours to produce a coating film having a thickness of from 0.11 to 0.14 mm. A sample piece was cut out from the coating film so as to have a width of 4 mm and a distance between clamps of 20 mm.
Measurement mode: Tensile
Measurement temperature: −100° C. to 150° C.
Heating rate: 4° C./min
Measurement data fetching interval: 4° C.
Vibration frequency: 10 Hz
Measurement strain: 0.10%

Discoloration properties, coating film durability, and printability of the obtained golf balls having marks on the coating film surfaces of Examples and Comparative Examples are evaluated by the following methods. The results are shown in Table 1.

### [Discoloration Properties]

A product obtained by mixing 20 g of spinach powder and 1 L of water for five minutes in advance with a mixer is put into a 10-liter poly container, and mixing is performed for three hours together with a coated golf ball. A degree of discoloration of the golf ball coating film to green is measured using a color difference meter to determine a color difference ΔE. Setting conditions of the color difference meter are as follows.

### [Setting Conditions]

The color difference is measured for the golf balls before and after the test by d/8 (measurement without including a specular reflection component of the sample: with a light trap) in accordance with JIS Z 8722 “Method for measuring reflective object” (optical system for diffusion light illumination and 8-degree reception: condition c) using a color difference meter (spectrophotometer “SC-P” manufactured by Suga Test Instruments Co., Ltd.). A measurement hole diameter φ of 30 mm is used. Then, respective values of L, a, and b and the color difference ΔE are measured based on a Lab color of JIS Z 8701.

### <Rating Criteria>

Then, from a value of the color difference ΔE measured using the color difference meter, the discoloration properties are evaluated according to the following criteria.
⊚: ΔE is not more than 10
◯: ΔE is at least 10 and not more than 20
Δ: ΔE is at least 20 and not more than 30
x: ΔE is at least 30

### [Coating Film Durability]

About 1.7 kg of sand having a size of about 5 mm and 1.7 L of water are put into a porcelain pot having an outer diameter of about 210 mm, and 15 balls are put into the porcelain pot. Then, the mixture is stirred with a ball mill apparatus at a rotation speed of 60±5 rpm for 120 minutes. Thereafter, the balls are taken out from the porcelain pot, and a degree of peeling of the surface coating is checked and evaluated according to the following criteria.

### <Rating Criteria>

⊚: There is little or no peeling of the coating.
◯: Peeling of the coating is slightly observed at several places.
Δ: Peeling of the coating is observed at several places.
x: Peeling of the coating is observed at several places, and further staining, deterioration of gloss, and the like are conspicuous.

### [Printability (Mark Durability)]

The printability (mark durability) is evaluated using an ADC Ball COR Durability Tester manufactured by Automated Design Corporation (U.S.). The tester has a function of firing a golf ball pneumatically and causing the golf ball to repeatedly strike two metal plates installed in parallel. An incident velocity on the metal plates is set to 43 m/s, each ball is fired 30 times, and an appearance of the mark after the test is visually observed.

### <Rating Criteria>

◯: There is almost no peeling or chipping of the mark.

Δ: Slight peeling or chipping of the mark is observed.

x: Large peeling or chipping of the mark is observed.

TABLE 1

| | | Comparative | | | | | | |
|---|---|---|---|---|---|---|---|---|
| | | Example | Example | | | | | |
| | | 1 | 1 | 2 | 3 | 4 | 5 | 6 |
| Main | Polyol | 30 | 30 | 30 | 30 | 30 | 30 | 30 |
| component | Organic solvent | 70 | 70 | 70 | 70 | 70 | 70 | 70 |
| (pbw) | Unreactive resin | | | | 1.0 | 2.0 | | |
| Curing agent | HDI | 42.0 | 37.8 | 35.7 | 36.1 | 33.9 | 33.6 | 24.4 |
| (pbw) | TDI | | | | | | 8.4 | 17.6 |
| | Organic solvent | 58.0 | 52.2 | 49.3 | 49.9 | 46.7 | 58.0 | 58.0 |

| | | | | | | | |
|---|---|---|---|---|---|---|---|
| Total compounding amount (pbw) of | 72.0 | 67.8 | 65.7 | 67.1 | 65.9 | 72.0 | 72.0 |
| coating material solid content | | | | | | | |
| Compounding amount (pbw) of | | | | 1.5 | 3.0 | | |
| unreactive resin | | | | | | | |
| Molar ratio: NCO/OH | 0.90 | 0.81 | 0.77 | 0.81 | 0.81 | 0.85 | 0.85 |
| 10% modulus (MPa) | 1.7 | 1.4 | 1.2 | 1.6 | 1.6 | 1.9 | 2.4 |
| Dynamic friction coefficient | 0.27 | 0.34 | 0.43 | 0.30 | 0.30 | 0.36 | 0.43 |
| Static friction coefficient | 0.55 | 0.62 | 0.77 | 0.65 | 0.65 | 0.71 | 0.88 |
| Peak temperature of tan δ (° C.) | 26.1 | 25.3 | 23.2 | 31.8 | 32.2 | 29.7 | 34.4 |
| Peak height of tan δ | 0.64 | 0.80 | 0.81 | 0.78 | 0.81 | 0.84 | 0.86 |
| Coating film discoloration properties | ◯ | ◯ | ◯ | ⊚ | ⊚ | ◯ | ⊚ |
| Coating film durability | ◯ | ⊚ | Δ | ⊚ | Δ | ◯ | Δ |
| Printability (mark durability) | X | Δ | ◯ | ◯ | ◯ | ◯ | Δ |

The components of the main component to be blended in the coating composition are as follows.
Polyol: Polyester polyol synthesized by the following method
Organic solvent: Mixture of ethyl acetate and butyl acetate at a weight ratio of 5.5:1
Unreactive resin: Cellulose acetate butyrate (CAB)

### [Synthesis of “Polyester Polyol”]

As the polyol as the main component in Table 1, a polyester polyol synthesized by the following method was used. A reactor equipped with a reflux condenser, a dropping funnel, a gas introduction tube, and a thermometer was charged with 140 parts by weight of trimethylolpropane, 95 parts by weight of ethylene glycol, 157 parts by weight of adipic acid, and 58 parts by weight of 1,4-cyclohexanedimethanol, and the contents were heated to 200 to 240° C. while stirring and heated (reacted) for five hours. Thereafter, a polyester polyol having an acid value of 4, a hydroxyl value of 170, and a weight average molecular weight (Mw) of 28,000 was obtained.

As shown in Table 1, Examples 1 to 6 have good printability (mark durability) while well maintaining the discoloration properties and durability of the coating film. On the other hand, in Comparative Example 1, since the molar ratio of NCO/OH in the coating composition is as large as 0.90, printability (mark durability) is poor.

Japanese Patent Application No. 2024-220293 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A golf ball comprising at least one coating layer on a surface of the golf ball having a large number of dimples, wherein at least one layer of the coating layer is formed of a two-liquid curable urethane coating composition containing a polyol component and a polyisocyanate component, a molar ratio (NCO group/OH group) of an isocyanate group (NCO group) of the polyisocyanate component to a hydroxyl group (OH group) of the polyol component is from 0.50 to 0.88, and a 10% modulus of the coating layer based on measurement of JIS K 7161 (2014) is not more than 3.0 MPa.

2. The golf ball of claim 1, wherein the coating composition contains an unreactive resin, and a compounding amount thereof is from 0.1 to 5.0 parts by weight per 100 parts by weight of a coating material solid content.

3. The golf ball of claim 1, wherein the unreactive resin is a cellulose-based resin.

4. The golf ball of claim 3, wherein the cellulose-based resin is cellulose acetate butyrate (CAB) or nitrocellulose.

5. The golf ball of claim 1, wherein the polyisocyanate component is composed of hexamethylene diisocyanate (HDI) and toluene diisocyanate (TDI), and a compounding ratio thereof is from 90/10 to 40/60 in terms of HDI/TDI (weight ratio).

6. The golf ball of claim 1, wherein the polyol component is an acrylic-based polyol or a polyester-based polyol.

7. The golf ball of claim 1, wherein a peak temperature of a loss tangent (tan δ) obtained by measuring a dynamic viscoelasticity of the coating layer is not more than 40° C.

8. The golf ball of claim 1, wherein a peak height of the loss tangent (tan δ) of the coating layer is from 0.70 to 0.90.

9. The golf ball of claim 1, wherein the coating layer includes two layers of an inner layer and an outer layer, the outer layer has a thickness of from 10 to 20 μm, and the inner layer has a thickness of from 3 to 7 μm.
